(19) United States
(12) Patent Application Publication
(10) Pub. No.: US 2021/0201683 A1
(43) Pub. Date: Jul. 1, 2021

(54) SYSTEM AND METHOD FOR PROVIDING SUPPORTIVE ACTIONS FOR ROAD SHARING

(71) Applicant: PANASONIC INTELLECTUAL PROPERTY MANAGEMENT CO., LTD., Osaka (JP)

(72) Inventors: Jan Jasper van den BERG, London (GB); Matthew John LAWRENSON, Chesterfield, MO (US)

(73) Assignee: PANASONIC INTELLECTUAL PROPERTY MANAGEMENT CO., LTD., Osaka (JP)

(21) Appl. No.: 17/201,336

(22) Filed: Mar. 15, 2021

Related U.S. Application Data
(63) Continuation of application No. PCT/JP2019/037388, filed on Sep. 24, 2019.
(60) Provisional application No. 62/735,221, filed on Sep. 24, 2018.

(51) Int. Cl. G08G 1/00; B64C 39/02; B60W 40/08; B60Q 1/46; G01C 21/34

(52) U.S. Cl. CPC G08G 1/202; B64C 39/024; G06Q 50/30; B60Q 1/46; G01C 21/3407; B60W 40/08

(57) ABSTRACT

A method for fulfilling an action request using a vehicle is provided. The method includes transmitting, from a computing device and to a server, an action request for fulfillment by a vehicle, the action request specifying a location of fulfillment. The method further includes identifying, by the server, a target vehicle equipped with an actuator configured to perform the action request among a plurality of vehicles, and transmitting, from the server and to the target vehicle, the action request for fulfillment using the actuator of the target vehicle. The method then routes the target vehicle to the location of fulfillment, and operates the actuator of the target vehicle for fulfilling the action request at the location of fulfillment.

### CROSS-REFERENCE TO RELATED APPLICATIONS

This application is a continuation of PCT International Patent Application No. PCT/JP2019/037388 filed on Sep. 24, 2019, which claims the benefit of priority of U.S. Provisional Patent Application No. 62/735,221 filed on Sep. 24, 2018, the entire contents of which are incorporated herein by reference.

### FIELD

The present disclosure relates to sharing of roads or spaces by various users, such as cars, bicycles, and pedestrians. For example, shared roads or spaces include bike friendly areas.

### BACKGROUND

Vehicles may be equipped with various actuators available to them with which they can influence their surroundings. Examples of such actuators include advance driving assistance systems, pixelated headlights, active aerodynamics, and external displays. Advanced driving assistance systems can help drivers to position themselves on the road with high accuracy. Pixelated headlights are headlights with individually controllable points to regulate the direction and strength of the illumination. Active aerodynamics are actuators on a vehicle which may be used to change the vehicle's shape, in order to control airflows around the vehicle and thereby optimize its aerodynamic behavior on the road.

Further, as limited roadways are shared by various users other than vehicles, a need for improved safety measures when sharing of common roads or spaces by multiple users, such as cyclists, vehicles and pedestrians, is present.

### SUMMARY

One aspect of the present disclosure may provide a method for fulfilling an action request via a vehicle, the method including: transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

Another aspect of the present disclosure may provide a non-transitory computer readable storage medium that stores a computer program, the computer program, when executed by a processor, causing a computer apparatus to perform a process for fulfilling an action request via a vehicle, the process including: transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

Yet another aspect of the present invention may provide a computer apparatus for fulfilling an action request via a vehicle, the computer apparatus including: a memory that stores instructions, and a processor that executes the instructions, wherein, when executed by the processor, the instructions cause the processor to perform operations including: transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

### BRIEF DESCRIPTION OF DRAWINGS

FIG. 1 shows an exemplary general computer system utilized for requesting and fulfilling an action request, according to an aspect of the present disclosure.

FIG. 2 shows an exemplary network environment for requesting and fulfilling an action request, according to an aspect of the present disclosure.

FIG. 3 shows an exemplary system environment for requesting and fulfilling an action request, according to an aspect of the present disclosure.

FIG. 4 shows an exemplary broadcasting system environment for requesting and fulfilling an action request, according to an aspect of the present disclosure.

FIG. 5 shows a method for facilitating a transaction between non-motorized road users and a vehicle in a centralized system in requesting and fulfilling an action request, according to aspects of the present disclosure.

FIG. 6 shows a method for facilitating a transaction between non-motorized road users and a vehicle in a non-centralized system, according to aspects of the present disclosure.

FIG. 7 shows a method for matching an action request to an action vehicle, according to aspects of the present disclosure.

FIG. 8 shows a method for identifying a proof collection device for deployment, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

According to exemplary embodiments, an action may refer to usage of vehicle actuators in such a way that they provide a benefit for someone other than the user of that vehicle. Further, an action vehicle may refer to a vehicle performing the action. A road user may refer to a user (e.g., pedestrian, cyclists, user of a second vehicle) requesting the action. An action request may refer to a database entry including the road user, the action and all other input parameters, such as the action request attributes, needed for the system to automatically perform that action in the desired way, e.g. location, timing, type and settings of the actuators, other user preferences. The action vehicle attributes may refer to a list of attributes describing for the action vehicle all related boundary conditions needed to determine if it is suitable to perform the action, e.g. available actuators and their capabilities, current usage of those actuators for other purposes than the action, vehicle user preferences such as their planned route, location and action type/settings they are willing to perform. Action proof data may refer to a set of sensor data which can be used to show an action has taken place, e.g. video, sound, location data, vehicle movement data, time-stamped data of actuator usage.

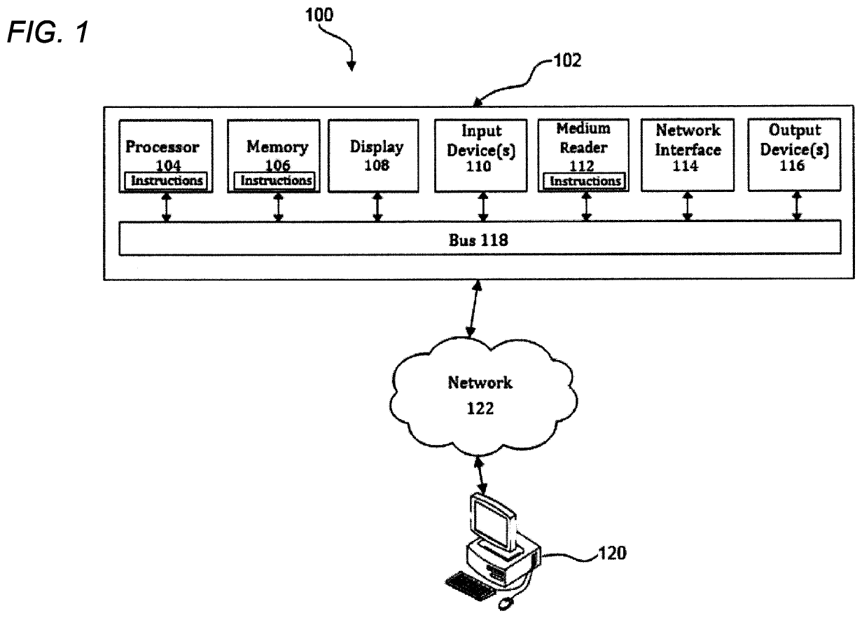

FIG. 1 is an exemplary computer system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT). a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read anyone or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present disclosure, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present disclosure. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

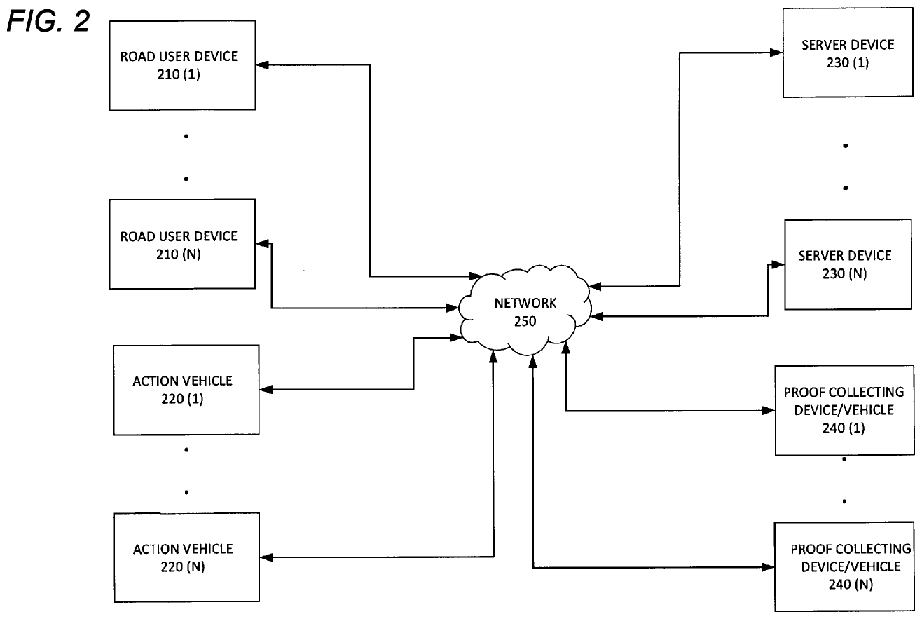

FIG. 2 shows an exemplary network environment for generating and fulling an action request, according to an aspect of the present disclosure.

Referring to FIG. 2, a schematic of an exemplary network environment for generating and fulfilling an action request is illustrated. In an exemplary embodiment, action request generation/fulfilment framework is executable on a networked computer platform.

In the network environment of FIG. 2, a plurality of road user devices 210(1)-210(N), a plurality of action vehicles 220(1)-220(N), a plurality of server devices 230(1)-230(N), and a plurality of proof collecting device/vehicle 240(1)-240(N) may communicate via communication network(s) 250.

A communication interface of a road user device, such as the network interface 114 of the computer system 102 of FIG. 1, operatively couples and communicates between the road user device, the server devices 230(1)-230(N), proof collecting device/vehicles 240(1)-240(N) and/or the action vehicles 220(1)-220(N), which are all coupled together by the communication network(s) 250, although other types and/or numbers of communication networks or systems with other types and/or numbers of connections and/or configurations to other devices and/or elements may also be used.

The communication network(s) 250 may be the same or similar to the network 122 as described with respect to FIG. 1, although the action vehicles 220(1)-220(N), the server devices 230(1)-230(N), and/or the proof collecting devices/vehicles 240(1)-240(N) may be coupled together via other topologies. Additionally, the network environment may include other network devices such as one or more routers and/or switches, for example, which are well known in the art and thus will not be described herein.

By way of example only, the communication network(s) 250 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 250 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The plurality of server devices 230(1)-230(N) may be the same or similar to the computer system 102 or the computer device 120 as described with respect to FIG. 1, including any features or combination of features described with respect thereto. For example, any of the server devices 230(1)-230(N) may include, among other features, one or more processors, a memory, and a communication interface, which are coupled together by a bus or other communication link, although other numbers and/or types of network devices may be used. The server devices 230(1)-230(N) in this example may process requests received from a client device via the communication network(s) 250 according to the HTTP-based and/or JavaScript Object Notation (JSON) protocol, for example, although other protocols may also be used.

The server devices 230(1)-230(N) may be hardware or software or may represent a system with multiple servers in a pool, which may include internal or external networks.

Although the server devices 230(1)-230(N) are illustrated as single devices, one or more actions of each of the server devices 230(1)-230(N) may be distributed across one or more distinct network computing devices that together comprise one or more of the server devices 230(1)-230(N). Moreover, the server devices 230(1)-230(N) are not limited to a particular configuration. Thus, the server devices 230(1)-230(N) may contain a plurality of network computing devices that operate using a master/slave approach, whereby one of the network computing devices of the server devices 230(1)-230(N) operates to manage and/or otherwise coordinate operations of the other network computing devices.

The server devices 230(1)-230(N) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of road user devices 210(1)-210(N) may also be the same or similar to the computer system 102 or the computer device 120 as described with respect to FIG. 1, including any features or combination of features described with respect thereto. For example, the road user devices 210(1)-210(N) in this example may include any type of computing device that can facilitate the execution of a web application or analysis that relates to an API. Accordingly, the road user devices 210(1)-210(N) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one road user device 210 is a wireless mobile communication device, i.e., a smart phone.

The road user devices 210(1)-210(N) may run interface applications, such as standard web browsers or standalone client applications, which may provide an interface to communicate with one or more of the action vehicles 220(1)-220(N), one or more of the proof collecting devices/vehicles 240(1)-240(N) and/or one or more of the server devices 230(1)-230(N) via the communication network(s) 250 in order to communicate user requests. The road user devices 210(1)-210(N) may further include, among other features, a display device, such as a display screen or touchscreen, and/or an input device, such as a keyboard, for example.

The proof collecting devices/vehicles 240(1)-240(N) may collect or capture proof of evidence of the action request submitted by one or more of the road user devices 210(1)-210(N). In an example, the proof collecting devices/vehicles 240(1)-240(N) may be one of the action vehicles 220(1)-220(N), a separate vehicle with proof collecting actuators (e.g., camera, microphone, light measurer, and etc.), an unmanned aerial vehicle (e.g., drone) with proof collecting actuators, an unmanned ground vehicles or the like.

Although the exemplary network environment with the road user devices 210(1)-210(N), the action vehicles 220(1)-220(N), the server devices 230(1)-230(N), the proof collecting devices/vehicles 240(1)-240(N), and the communication network(s) 250 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as the road user devices 210(1)-210(N), or the server devices 230(1)-230(N), for example, may be configured to operate as virtual instances on the same physical machine. In other words, one or more of the server devices 230(1)-230(N), or the road user devices 210(1)-210(N) may operate on the same physical device rather than as separate devices communicating through communication network(s) 250.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

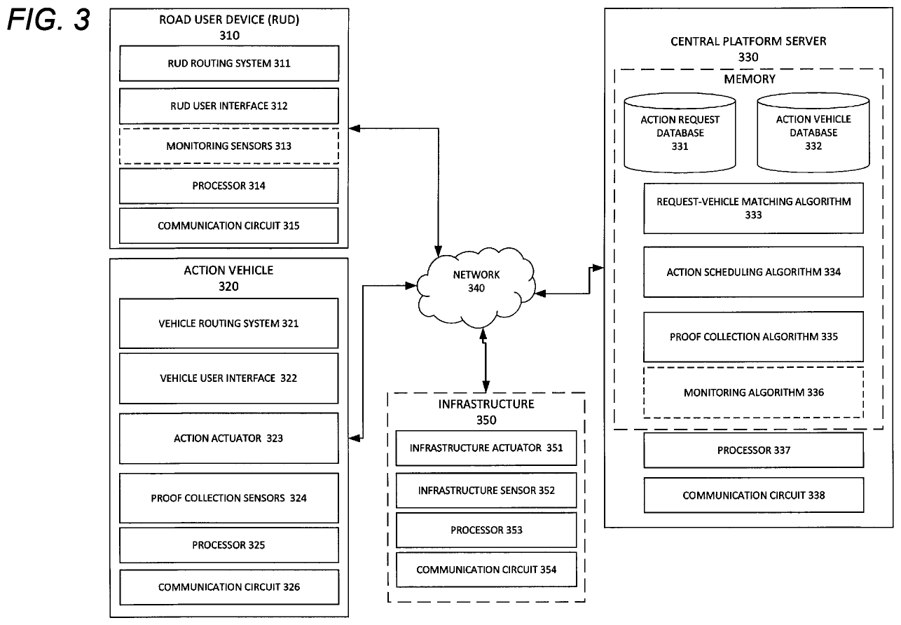

FIG. 3 shows an exemplary centralized system environment for requesting and fulfilling an action request, according to an aspect of the present disclosure.

System 300 includes a road user device (RUD) 310, an action vehicle 320, a central platform server 330, and a network 340. The system 300 may optionally include an infrastructure 350.

The RUD 310 may be a portable computing device with communication capabilities. For example, RUD 310 may include a smart phone, a smart watch, a fitness tracking device, an emergency signal transmission device, wearable electronics and other portable computing devices having communication capabilities. The RUD 310 may be used to submit an action request to be fulfilled by the action vehicle 320. In an example, the action request may be a request for one or more action vehicles perform an action using their actuators (e.g., pixelated headlights, windows, external display(s), sound system, alarm system, and the like). For example, the action request may request an action vehicle to provide warning lights to warn other drivers when a user of the RUD 310 may be stranded on a dark road or if there is a potential danger on the road. In another example, the action request may request an action to provide visible light for walking on a dark path. An action request may be requested for the user of the RUD 310 or for another user, a particular location or venue, or the like. The action request may also specify fulfillment conditions (e.g., completion of a certain task, duration of time, providing brightness of a certain level, and a completion condition). The completion condition may for example, include, providing of warning lights or warning display until arrival of an emergency vehicle or a tow truck.

The action vehicle 320 may include a vehicle that performs an action requested by the RUD 310. For example, the action vehicle 320 may be an autonomous vehicle (AV), a vehicle with one or more actuators, an unmanned aerial device (e.g., drones) with one or more actuators and the like. The actuators may include, without limitation, pixelated headlights, a loud speaker, external display, motorized vehicle parts (e.g., retractable spoiler) and the like.

The central platform server 330 may be a network server or a set of network servers interconnected with one another. Further, the central platform server 330 may be a physical server or a virtual server. The RUD 310, action vehicle 320, and the central platform server 330 may be interconnected with one another over the network 340.

The network 340 may be a communication network, a mobile communication network, a cloud network, other communication networks or a combination thereof. The network 340 may include local area network(s) (LAN(s)) or wide area network(s) (WAN(s)), and can use TCP/IP over Ethernet and industry-standard protocols, although other types and/or numbers of protocols and/or communication networks may be used. The network 340 may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RUD 310 includes a RUD routing system 311, a RUD user interface 312, a processor 314 and a communication circuit 315. The RUD 310 may optionally include one or more monitoring sensors 313. The monitoring sensors 313 may capture various inputs for generating an action request. In an example, the monitoring sensors 313 may refer to one or more sensors that monitors the RUD 310, the action vehicle 320 or its environment. The monitoring sensors 313 may include, for example, light sensors to measure lighting conditions to determine if a user of the RUD 310 has adequate or desired illumination. In another example, the monitoring sensors 313 may include a camera to monitor the action vehicle 320 or a condition of the road (e.g., road damage).

In an example, the RUD routing system 311 may be a routing system provided on the RUD 310. The RUD routing system 311 may be implemented by a processor and a transceiver. The RUD routing system 311 may be used to plan a route and indicate one or more locations within the planned route at which an action requested by the RUD 310 may be executed. The RUD routing system 311 may receive a GPS signal for other communication signals for determining a location of the action vehicle 320 and a location at which the requested action is to be performed. The RUD routing system 311 may also show a progress of travel by an action vehicle assigned to perform the action request. Additionally, the RUD routing system 311 may indicate a location of the RUD 310. The RUD routing system 311 may determine a route from the location of the action vehicle 320 based on one or more parameters or preferences. For example, the RUD routing system 311 may determine a route based on fastest time, shortest distance, cost, road conditions (e.g., presence of potholes, loose rocks, and etc.), avoidance of toll roads, scheduled time for performing the action request and the like. In an example, faster routes with toll roads may incur higher cost to the user requesting the action request. Further, the RUD routing system 311 may determine a route based on traffic and/or weather information.

In an example, the RUD user interface 312 may include a display interface, which may be provided by a mobile application, for a road user to input an action request, and/or a voice interface. The RUD user interface 312 may be utilized by a user to submit an action request to be fulfilled by an action vehicle. Such request may be inputted via an intentional touch, voice, gesture, and the like. However, aspects of the present disclosure are not limited thereto, such that the action request may be automated. For example, if a voice level above a certain threshold is detected or a sudden spike in heart rate is detected, an action request may be automatically submitted to bring attention to the location of the RUD 310. In response an action vehicle with lights and/or siren or other noise making capabilities may be dispatched.

The RUD user interface 312 may receive an input via a touch, operating of a physical controller (e.g., button, switch, scroller, knob and etc.), voice, bio signals (e.g., finger print) and the like. In an example, the RUD user interface 312 may include a display, which may be a touch display or a display only, a microphone, and one or more sensors. The one or more sensors may include a bio sensor, which may acquire one or more bio sensors of the user. For example, the bio sensor may include a contact type sensor, such as those that reads a finger print of a user. However, aspects of the present disclosure are not limited thereto, such that the bio sensor may include non-contact based sensors, which may measure human pulse waves in a non-contact manner by using a highly sensitive spread-spectrum millimeter-wave radar or the like, for detecting the heart rate and heart rate fluctuations of the user. In another example, the bio sensor may include a camera, which may determine a heart rate based on change in color of a skin area of the user with respect to time.

Further, the RUD 310 may optionally also include one or more monitoring sensors 313. In an example, the monitoring sensors 313 may refer to sensors which may be used to collect environmental information surrounding the RUD 310. For example, the environmental information may include, without limitation, lighting conditions, sound conditions, rate of crime, time of day, day of week, presence of special events, number of people within a reference vicinity, and location of other persons with respect to the RUD 310. In addition, the one or more monitoring sensors 313 may be configured to collect action proof data as evidence of fulfillment of the action request by the assigned action vehicle. In an example, the action proof data may refer to a set of sensor data which can be used to show an action has taken place, e.g. video, sound, location data, vehicle movement data, time-stamped data of actuator usage, and the like. The sensors may include an image sensor, a light sensor, a GPS sensor, an infrared sensor, a microphone, a bio sensor and the like. For example, the bio sensor may include a sensor that measures human pulse waves in a non-contact manner by using a highly sensitive spread-spectrum millimeter-wave radar or the like, for detecting the heart rate and heart rate fluctuations of the user. In another example, the bio sensor may include a camera, which may determine a heart rate based on change in color of a skin area of the user with respect to time.

The processor 314 may perform one or more executions in response to an input received via one or more of the RUD routing system 311, RUD user interface 312, monitoring sensors 313 and the communication circuit 315. The processor 314 may provide an output via one or more of the of the RUD routing system 311, RUD user interface 312 and the communication circuit 315. The communication circuit 315 may be configured to communicate with the network 340 and/or the action vehicle 320. In an example, the communication circuit 315 may include a transmitter, a receiver, and/or a transceiver.

The action vehicle 320 includes a vehicle routing system 321, a vehicle user interface 322, an action actuator 323, a proof collection sensor 324, a processor 325 and a communication circuit 326.

The vehicle routing system 321 may be a routing system that plans a route and indicate within the route one or more locations where an action may be available for fulfilment by the respective action vehicle 320. The vehicle routing system 321 may be implemented by a processor, a GPS sensor and/or a transceiver. The vehicle routing system 321 may be used to plan a route and indicate one or more locations within the planned route at which an action requested may be executed. In an example, the vehicle routing system 321 may plan multiple routes in relation to or in consideration of other action requests.

In an example, the vehicle routing system 321 may receive a GPS signal for other communication signals for determining a location of the action vehicle 320 and a location at which the requested action is to be performed. The vehicle routing system 321 may determine a route from the location of the action vehicle 320 based on one or more parameters or preferences. For example, the vehicle routing system 321 may determine a route based on fastest time, shortest distance, cost, road conditions (e.g., presence of potholes, loose rocks, and etc.), avoidance of toll roads, scheduled time for performing the action request and the like. Further, the vehicle routing system 321 may determine a route based on traffic and/or weather information. The vehicle routing system 321 may also determine a route in consideration of locations of multiple action requests received.

The vehicle user interface 322 may be an interface for an occupant or a user in the action vehicle 320 to utilize. For example, the occupant may user the vehicle user interface 322 to input one or more inputs, such as action vehicle attributes. The action vehicle attributes may include, for example, location or route information about the action vehicle 320's general availability to perform actions in response to action requests. Further, the vehicle user interface 322 may be used to input a response directly to a specific action request. The vehicle user interface 322 may be a touch screen utilizing an underlying software. Further, the vehicle user interface 322 may be fixed to the action vehicle 320, or may be portable device that connects to the action vehicle 320. The portable device may be connected by a wire or via a direct wireless communication with the action vehicle 320.

The action actuator 323 may include a vehicular component that may perform the requested action. The action actuator 323 may include one or more vehicular components. For example, the action actuator 323 may include a driving assistance system, pixelated headlights, aerodynamic actuators (e.g., controllable roof spoiler), external displays, road projectors and the like. The action actuator 323 may be able to perform the action under different settings, such as brightness of headlights/projector, trajectory and speed settings for guidance of the driver.

The proof collection sensor 324 may include one or more sensors to collect action proof data. The proof collection sensor 324 may include, without limitation, an image sensor, a microphone, location sensor, inertia sensor, and a dedicated sensor for the action actuator(s). In an example, the proof collection sensor 324 may measure additional sensor data, such as road usage data, to obtain information about road usage or road user behaviour, e.g. behaviour of other vehicles in response to an action request being fulfilled. The road usage data may have value, for instance for city services or transport authorities, and therefore may be additional data for collection in the action proof data.

The processor 325 may perform one or more executions in response to an input received via one or more of the vehicle routing system 321, the vehicle user interface 322, the action actuator 323, the proof collection sensor 324 and/or the communication circuit 326. The processor 325 may provide an output via one or more of the vehicle routing system 321, the vehicle user interface 322, the action actuator 323, the proof collection sensor 324 and/or the communication circuit 326. The communication circuit 326 may be configured to communicate with the network 340 and/or the RUD 310. In an example, the communication circuit 326 may include a transmitter, a receiver, and/or a transceiver.

The central platform server 330 includes an action request database 331, an action vehicle database 332, a request-vehicle matching algorithm 333, an action scheduling algorithm 334, and a proof collection algorithm 335. Further, the central platform server 330 may optionally include a monitoring algorithm 336. One or more of the action request database 331, the action vehicle database 332, the request-vehicle matching algorithm 333, the action scheduling algorithm 334, the proof collection algorithm 335 and the monitoring algorithm 336 may be stored in a memory of the central platform server 330.

The central platform server 330 further includes a processor 337 that may retrieve data from the action request database 331 and/or the action vehicle database 332, and executes one or more of the request-vehicle matching algorithm 333, the action scheduling algorithm 334, the proof collection algorithm 335 and the monitoring algorithm 336.

The central platform server 330 further includes a communication circuit 338 for communicating with the network 340. In an example, the communication circuit 338 may include a transmitter, a receiver, and/or a transceiver.

In an example, the action request database 331 stores one or more action requests received from one or more RUDs 310. Although the action requests are described as being generated and transmitted by the RUD 310, aspects of the present disclosure are not limited thereto, such that a vehicle with computing and communication capabilities may also generate and transmit an action request for fulfillment. In an example, a vehicle or the RUD 310 may generate an action request in form of a distress signal (e.g., SOS). In an example, the one or more action requests may be grouped based on type, priority, location, actuator for performing the action request, and the like. In addition, the action request may be prioritized based on importance. For example, action requests related to health and/or safety of a requester may be prioritized to be fulfilled over other non-emergency action requests.

The action vehicle database 332 may store a listing of action vehicles available and their corresponding attributes. Attribute information may include, without limitation, description information (e.g., year, make, model, color and etc.), list of actuators, rating information, duration of service, operation periods, operation areas, type or list of tasks available for performance, type of employment (e.g., freelance or employee of a service provider or a fleet) and the like.

According to aspects of the present disclosure, the action vehicle entries stored in the action vehicle database 332 may be created based on one or more data inputs. The one or more data inputs include map/routing data from the vehicle routing system 321, user preferences/constraints inputted via the vehicle user interface 322 and data describing the capabilities of the action actuator 323 installed or mounted on the vehicle. In an example, user preferences/constraints may include, without limitation, a time window for the action being requested, maximum delay caused by the action being requested and the like.

In an example, the request-vehicle matching algorithm 333 may refer to an algorithm that receives an action request and a list of potential action vehicles and their related action vehicle attributes as inputs, and based on such inputs, creates a list of potential action vehicles suited to perform the action request. The list of potential action vehicles may be ranked based on one or more factors, which may include user preference, user status/type, user value (e.g., new, highly valued, low valued, and etc.), vehicle information or the like.

In an example, the request-vehicle matching algorithm 333 may match an action vehicle listed in the action vehicles database 332 with a received action request based on a location of the action request to be performed. However, aspects of the present disclosure are not limited thereto, such that the action request may be matched up with an action vehicle based on wait time, rating information, employment type information, type of vehicle and the like. Further, the action request may be matched up with an action vehicle based on requester information. For example, a more experienced action vehicle may be assigned to a new user or a more valued user.

Further, in another example, the request-vehicle matching algorithm 333 may select an action vehicle

In an example, the action scheduling algorithm 334 may be an algorithm which receives as input, one or more of map/routing data, attributes of action requests, and attributes of action vehicles. Further, the action scheduling algorithm 334, based on the received input, may create an instruction for the action actuators or action actuation instructions. The action actuation instructions may include instructions for one or more actuators of the action vehicle 320 to perform the action being requested. For example, the action actuation instruction may specify time and location within the routes of both a road user and the action vehicle, as well as settings of the action actuator 323.

Once the action request is scheduled to be fulfilled, travel route of the action vehicle 320 may be modified based on a location at which the action request is to be fulfilled. Further, the travel route of the action vehicle 320 may be modified based on a time frame in which the action request it to be fulfilled. In addition, the modified travel route may be displayed on the vehicle user interface 322 of the action vehicle 320. The modified travel route may also display a marker representing the action request to be fulfilled on the travel route.

In an example, the proof collection algorithm 335 may receive, as input, the action actuation instructions and optionally attributes of the action request and the action vehicle 320. The proof collection algorithm 335 may receive the input to determine capabilities of various sensors on the action vehicle 320, such as proof collection sensors 324 and optional monitoring sensors 313 of the RUD 310. Based on the received inputs, the proof collection algorithm 335 may create a description (e.g., proof collection instructions) of which data is to be collected to create actuation proof data.

In an example, the monitoring algorithm 336 may use the input provided by the monitoring sensors 313 to automatically generate action request attributes or action vehicle attributes.

The infrastructure 350 includes an infrastructure actuator 351, an infrastructure sensor 352, a processor 353 and a communication circuit 354. In an example, the infrastructure actuator 351 may include smart lighting, automated doors, thermostat, sirens or the like. The infrastructure sensors 352 may include, without limitation, security camera, infrared sensors, microphones or the like. In another example, at locations where action actuators 323 are used, an action (or part of the action) being requested may be performed by the infrastructure actuator 351. Further, at locations where proof collection sensors 324 or monitoring sensors 313 are used, the data gathering or part of the data gathering may be performed by the infrastructure sensor 352.

In an example, the communication network 340 may include local area network(s) (LAN(s)) or wide area network(s) (WAN(s)), and can use TCP/IP over Ethernet and industry-standard protocols, although other types and/or numbers of protocols and/or communication networks may be used. The communication network 340 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Although various components are described herein, aspects of the present disclosure are not limited thereto. Further, although singular components are listed in the figures, aspects of the present disclosure are not limited thereto, such that multiple components may be included.

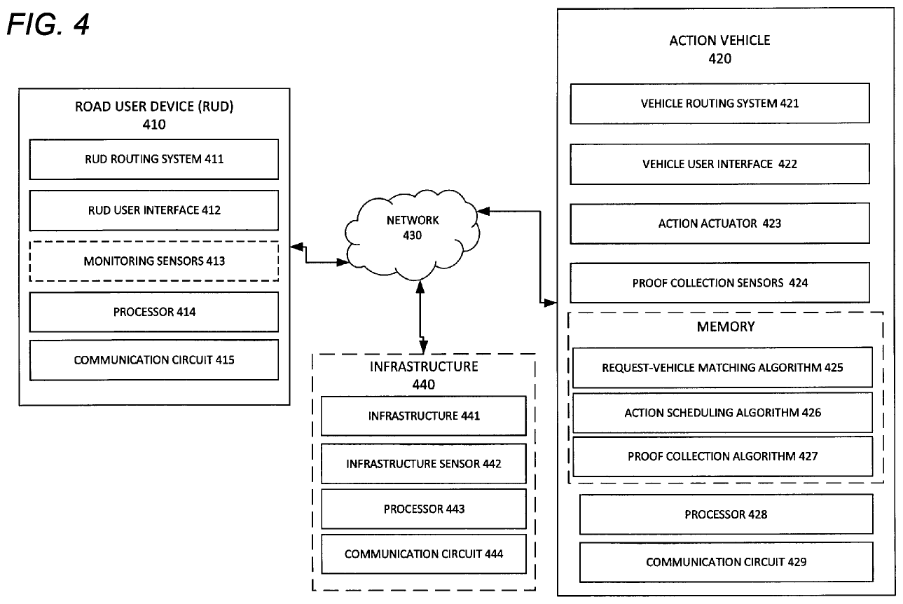

FIG. 4 shows an exemplary broadcasting system environment for requesting and fulfilling an action request, according to an aspect of the present disclosure.

System of FIG. 4 includes a road user device (RUD) 410, an action vehicle 420, and a communication network 430. The system of FIG. 4 may optionally include an infrastructure 440.

The RUD 410 may be configured similarly to the RUD 310 of FIG. 3 except for the communication circuit 415. The communication circuit 415, although capable of performing communication with a centralized network server, is configured to communicate with action vehicle 420 through the network 430, without performing additional communication with the centralized network server. In an example, rather than submitting an action request to a centralized network server for fulfillment, the communication circuit 415 broadcasts or transmits an action request directly to one or more action vehicles present within a reference distance from the RUD 410 or from a location at which the action request is to be performed. In an example, the action request may be broadcasted as a network signal, a network message, a text message, and the like. Similarly, the action vehicle 420 may communicate with the infrastructure 440 without relying on a centralized network server for facilitating interaction between the two.

The action vehicle 420 may include one or more features similar to the action vehicle 320 of FIG. 3. The action vehicle 420, similar to action vehicle 320, includes a vehicle routing system 421, a vehicle user interface 422, an action actuator 423, and a proof collection sensor 424. One or more of the vehicle routing system 421, the vehicle user interface 422, the action actuator 423, and the proof collection sensor 424, may be similarly configured with the vehicle routing system 321, the vehicle user interface 322, the action actuator 323, and the proof collection sensor 324.

However, in addition to the above noted components, the action vehicle 420 further includes a request-vehicle matching algorithm 425, an action scheduling algorithm 426, and a proof collection algorithm 427. The request-vehicle matching algorithm 425, the action scheduling algorithm 426, and the proof collection algorithm 427 may be stored in a memory of the action vehicle 420.

The action vehicle 420 also includes a processor 428 and a communication circuit 429. The processor 428 may execute one or more of the request-vehicle matching algorithm 425, the action scheduling algorithm 426, and the proof collection algorithm 427. The action vehicle 420 further includes a communication circuit 429 for communicating with the RUD 410 via the network. In an example, the communication circuit 429 may include a transmitter, a receiver, and/or a transceiver.

In an example, the request-vehicle matching algorithm 425 may refer to an algorithm that receives an action request and a list of potential action vehicles and their related action vehicle attributes as inputs, and based on such inputs, creates a list of potential action vehicles suited to perform the action request. The list of potential action vehicles may be ranked based on one or more factors, which may include user preference, user status/type, user value (e.g., new, highly valued, low valued, and etc.), vehicle information or the like.

In an example, the request-vehicle matching algorithm 425 may match a receiving action vehicle with a received action request based on a location of the action request to be performed. However, aspects of the present disclosure are not limited thereto, such that the action request may be matched up with an action vehicle based on wait time, rating information, employment type information, type of vehicle and the like. Further, the action request may be matched up with an action vehicle based on requester information. For example, a more experienced action vehicle may be assigned to a new user or a more valued user.

In an example, the action scheduling algorithm 426 may be an algorithm which receives as input, one or more of map/routing data, attributes of action requests, attributes of action vehicles, and based on the received input, creates an instruction for the action actuators (or action actuation instructions). The action actuation instructions specify for one or more actuators of the action vehicle to perform the action. For example, the action actuation instruction may specify time and location within the routes of both a road user and the action vehicle, as well as settings of the action actuator.

Once the action request is scheduled to be fulfilled, travel route of the action vehicle may be modified based on a location at which the action request is to be fulfilled. Further, the travel route of the action vehicle may be modified based on a time frame in which the action request it to be fulfilled. In addition, the modified travel route may be displayed on a user interface of the action vehicle. The modified travel route may also display a marker representing the action request to be fulfilled on the travel route.

In an example, the proof collection algorithm 427 may receive, as input, the action actuation instructions and optionally attributes of the action request and the action vehicle. The proof collection algorithm 427 may receive the input to determine capabilities of various sensors on the action vehicle, such as proof collection sensors 424. Based on the received inputs, the proof collection algorithm 427 creates a description (e.g., proof collection instructions) of which data is to be collected to create actuation proof data.

In an example, the communication network 430 may include local area network(s) (LAN(s)) or wide area network(s) (WAN(s)), and can use TCP/IP over Ethernet and industry-standard protocols, although other types and/or numbers of protocols and/or communication networks may be used. The communication network 430 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Although various components are described herein, aspects of the present disclosure are not limited thereto. Further, although singular components are listed in the figures, aspects of the present disclosure are not limited thereto, such that multiple components may be included.

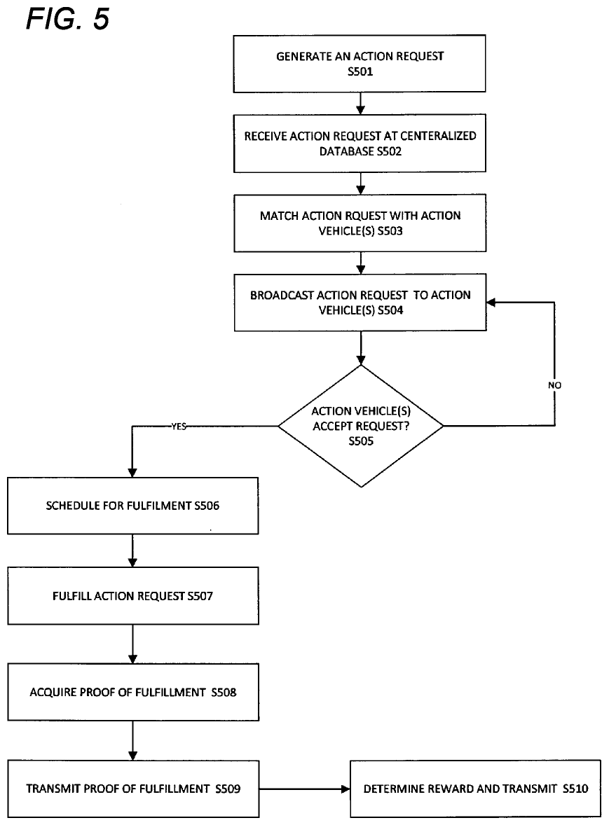

FIG. 5 shows a method for facilitating a transaction between non-motorized road users and a vehicle in a centralized system in requesting and fulfilling an action request, according to aspects of the present disclosure.

In operation S501 an action request is generated using a computing device. In an example, the computing device may include, without limitation, a computer, a mobile device, a smart phone, a wearable smart device, a computing device installed/mounted on a vehicle, and the like. The action request may be intentionally (e.g., by a manual input) or unintentionally (e.g., based on a bio signal detection, such as drowsiness or other medical condition) requested by a non-motorized road user or a government entity. In an example, the non-motorized road user may be a person, a cyclist and other persons using a road that is not using a motorized vehicle. The government entity may include governmental agencies responsible for management of road conditions and/or public safety. The motorized vehicle may include a gasoline powered automobile, an electric automobile, a hybrid automobile and the like. The motorized vehicle may be a fully functioning autonomous vehicle, a vehicle with one or more autonomous (or driver assisting) features, or a vehicle with no autonomous features.

The action request may request for an action to be performed by a vehicle. The action request may specify an action to be performed, actuators for performing of the action, timeframe in which the action is to be performed, location of the action to be performed, and reward corresponding to the action. Further, the action request may also specify a number of vehicles for performing the action, type of vehicles (e.g., SUV, sports car, vans, sedans, trucks and the like).

The action to be performed by a vehicle may include any action performed using an actuator on the vehicle, such as use of external displays, warning lights, pixelated headlights, horns, sound system, spoilers, and the like. The action being requested may specify to light up dark roads or paths, warn/notify other users of road by using external displays or warning lights, alert bystanders of a situation by making loud noises via the horns or sound system. Further, the action request may be specified by a governmental agency to alert other drivers of a potential danger by blocking off a section of a road by using the action vehicle(s) and their flashers. In an example, the action request may be generated in real-time or scheduled in advance for fulfilment.

In operation S502, the generated action request is received at a centralized database server, such as an action request database. The action request generated in operation S501 and/or other action requests generated by other user devices may be stored in the centralized database server. The received action request may be entered in as an input to the action request database, and may be referred to as action request data base entries. The action request data base entries may be created and/or organized based on one or more data inputs. For example, the data inputs may include map/routing data from a RUD routing system, action request attribute inputs provided by one or more road users via a user interface (e.g., RUD user interface), and/or action requests provided by third parties. For example, third party may include municipalities, which may request action requests for purposes of providing public safety, such as illumination of dark streets (e.g., originally or due to an outage) via vehicle headlights.

In an example, the action requests may be stored based on reception time, location from which the action request is generated, location at which the action request is to be fulfilled, or according to other criteria. Further, the action requests may be prioritized in accordance with one or more predetermined parameters. The predetermined parameters may include, without limitation, priority (e.g., health and safety may be top priority), requested time, reward amount, requester status (e.g., higher valued users may receive priority) and the like. The action request database may reside over a communication network, a mobile network, a cloud network and the like.

In operation S503, the stored action request is matched with one or more of action vehicles listed or stored in a centralized database server, such as an action vehicles database, for fulfilling the action request generated in operation S501. The action vehicles may refer to a vehicle that has registered with a service provider for fulfilling an action request. The action vehicles may have a designated operation time periods, designated areas, designated tasks they are willing to perform, or may operate as a freelancer. The action vehicles database may store various attribute information of the registered action vehicles. attribute information may include, without limitation, description information (e.g., year, make, model, color and etc.), list of actuators, rating information, duration of service, operation periods, operation areas, type or list of tasks available for performance, type of employment (e.g., freelance or employee of a service provider or a fleet) and the like.

The matching of the action vehicles and the action request may be performed at a centralized server using a request-vehicle matching algorithm, which may be stored in a memory of the centralized server and executed by a processor of the centralized server. The request-vehicle matching algorithm may refer to an algorithm that receives an action request and a list of potential action vehicles and their related action vehicle attributes as inputs, and based on such inputs, creates a list of potential action vehicles suited to perform the action request. The list of potential action vehicles may be ranked based on one or more factors, which may include user preference, user status/type, user value (e.g., new, highly valued, low valued, and etc.), vehicle information, vehicle availability, vehicle pricing or the like.

In an example, the request-vehicle matching algorithm may match an action vehicle listed in the action vehicles database with a received action request based on a location of the action request to be performed. However, aspects of the present disclosure are not limited thereto, such that the action request may be matched up with an action vehicle based on other criteria, which may include, without limitation, equipped actuators, wait time, rating information, employment type information, type of vehicle and the like. Further, the action request may be matched up with an action vehicle based on requester information. For example, a more experienced action vehicle may be assigned to a new user or a more valued user.

In an alternative example, the request-vehicle matching algorithm may be stored in a memory of an action vehicle and executed by a process of the action vehicle. In this configuration, the action vehicle may receive an action request directly from a road user device via a network. More specifically, the action request may be broadcasted to a plurality of action vehicles instead of being transmitted to a centralized server. In an example, the action request may be broadcasted to one or more action vehicles located within a reference range of the road user device or a location at which an action being requested is to be performed. The action vehicle receiving the broadcasted action request may compare the action request with the action vehicle's attributes. In response to the comparison, the request-vehicle matching algorithm may output information about their match. The information outputted may indicate, for example, match, no match, rerouting, delay or the like.

In operation S504, the action request is selectively broadcasted to the action vehicles matched in operation S503. For example, the action request may be broadcasted contemporaneously to all of the Action Vehicles, or may be broadcasted accordingly to a certain criteria, such as distance. However, aspects of the disclosure are not limited thereto, such that the action request may be broadcasted to action vehicles located within a certain geographic area.

In operation S505, a determination of whether one or more of the action vehicles receiving the broadcasted action request accepts to fulfill the action request. In an Example, the action vehicle may opt to fulfill the action request by receiving an input on a user interface of the action vehicle. In another example, the action vehicle may be configured to automatically opt to fulfill the action request based on a profile. The profile of the action vehicle may specify the action vehicle to automatically accept action requests received during certain hours, received within a preset geographic region, receiving within a predetermined distance, specifies use of a particular actuator, received from a user of a certain rating or type, and the like.

If the one or more of the action vehicles receiving the broadcasted action request are detected as accepting the action request after a predetermined period, transmissions, reaching predetermined number of action vehicles, the broadcasting of the action request may cease and the method proceeds to operation S506. On the other hand, if it is determined that the one or more of the action vehicles receiving the broadcasted action request do not accept to fulfill the action request, then the method proceeds back to operation S504 to rebroadcast the action request. In an example, a determination of non-acceptance may be made if a number of action vehicles accepting the action request is less than a predetermined number after a predetermined period of time or transmissions. Further, the determination of non-acceptance may be made if the accepting action vehicle does not match a condition or preference specified in a profile of a user or RUD or in the action request. For example, the action request may specify only sport cars or cars of certain brand to accept the action request.

In operation S506, the action vehicle accepting to fulfill the action request is scheduled for fulfilment. In an example, the action vehicle may be scheduled according to an action scheduling algorithm, which may be stored in a memory of a centralized server device, and executed by a processor of the centralized server device. The action scheduling algorithm may be an algorithm which receives as input, one or more of map/routing data, attributes of action requests, attributes of action vehicles, and based on the received input, creates an instruction for the action actuators (or action actuation instructions). The action actuation instructions for one or more actuators of the action vehicle to perform the action. For example, the action actuation instruction may specify time and location within the routes of both a road user and the action vehicle, as well as settings of the action actuator. The action scheduling algorithm may calculate a preferred or best location, time and other parameters for the action to be executed.

Once the action request is scheduled to be fulfilled, travel route of the action vehicle may be modified based on a location at which the action request is to be fulfilled. Further, the travel route of the action vehicle may be modified based on a time frame in which the action request it to be fulfilled. In addition, the modified travel route may be displayed on a user interface of the action vehicle. The modified travel route may also display a marker representing the action request to be fulfilled on the travel route.

In operation S507, the action vehicle fulfills the action request. The action request may be fulfilled by one or more actuators of the vehicle. For example, the action request may include using hazard lights near an accident site, illumination of head lights in a dark area, and the like. In this scenario, for example, the action vehicle traveling beside the sidewalk may be controlled to illuminate the steps on the sidewalk. In another example, the action request may include using a camera mounted on the action vehicle. In this scenario, for example, if a person, bicycle, or motorcycle that is about to snatch possessions of a pedestrian is found, the pedestrian may be alerted. In another example, the action request may include one or more action vehicles, which may require coordination between the action vehicles. In this scenario, each action may be tasked to perform a particular portion of the action to be performed. For example, the action request may specify for multiple vehicles to surround an accident site, and may further specify each vehicle to be positioned at a certain location with respect to the accident site or other vehicles. In another example, the action request may specify multiple vehicles ahead an emergency vehicle such as an ambulance, and may further specify each vehicle to move into a lane away from the emergency vehicle.

In operation S508, sensors of the action vehicles detect operation(s) of the actuators in fulfilling the action request and capture corresponding evidence of fulfillment. For example, the detection data may be stored as proof of fulfillment of the action request. However, aspects of the present disclosure are not limited thereto, such that sensors of other action vehicles may be utilized in capturing proof of fulfillment of the action request. In an example, the other action vehicles may include other action vehicles, which may not be assigned to any particular action requests, an unmanned aerial device (e.g., drone), infrastructure cameras (e.g., security cameras of nearby buildings or traffic lights), and the like.

In an example, the proof of fulfillment may be captured in accordance with an algorithm, such as a proof collection algorithm. In an example, the proof collection algorithm may be stored in a memory of a centralized server and executed by a processor of the centralized server. The proof collection algorithm may receive, as input, the action actuation instructions and optionally, attributes of the action request and the action vehicle. The proof collection algorithm may receive the input to determine capabilities of various sensors on the action vehicle, such as proof collection sensors and optional RUD monitoring sensors. The proof collection algorithm may optionally receive, as input, map/route data from both the action vehicle and the road user device, such as, positional/route data that may be used to determine who may be in the best position to collect the action proof data. In an example, one or both of the action vehicle fulfilling the action request and/or the road user device submitting the action request may collect the action proof data. However, aspects of the present disclosure are not limited thereto, such that other action vehicles or road user devices may collect the action proof data.

Based on the received inputs, the proof collection algorithm creates a description (e.g., proof collection instructions) of which data is to be collected to create actuation proof data. Following the action actuation instructions and the proof collection instructions, the action actuator performs the action while the proof collection sensors collect the action proof data.

In operation S509, data related to the proof of fulfilment is transmitted to a centralized server over a network. The server updates its information to reflect the fulfilment of the action vehicle, such as a current status of the action vehicle, level information, and other status modifiers.

In operation S510, a reward is determined for the action vehicle, and transmitted to the action vehicle. In an example, the determined reward may be a reward that was originally specified in the action request. Further, the originally determined reward may be adjusted based on one or more parameters, such as delay of performance or quality of performance.

Although various aspects of the present disclosure were made with respect to action vehicles being motorized road vehicles, aspects of the present disclosure are not limited thereto, such that the action vehicles may include any vehicle or device having one or more actuators for performing an action request. For example, an action vehicle may include an unmanned aerial device (e.g., drone) equipped with LED lights, cameras, and a speaker. Further, an action vehicle may also include an automated cleaning robot/vehicle, which may be deployed to remove certain debris from a public road.

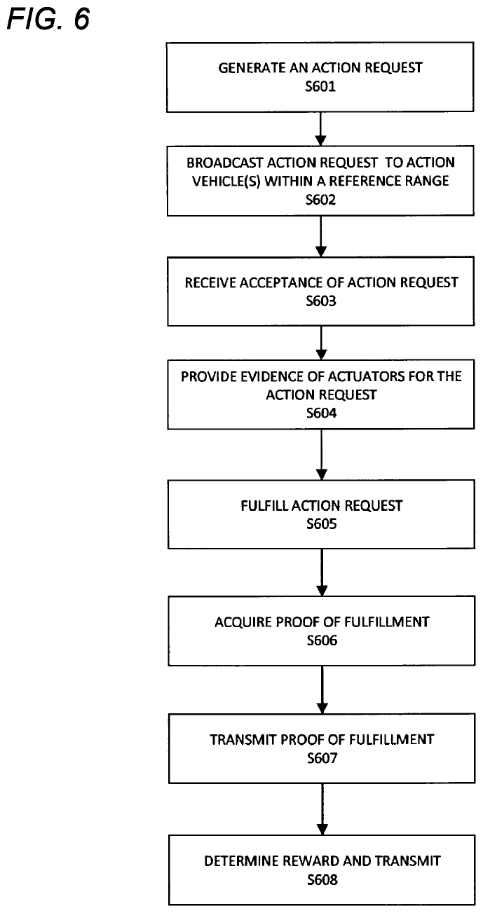

FIG. 6 shows a method for facilitating a transaction between non-motorized road users and a vehicle in a non-centralized system, according to aspects of the present disclosure.

In operation S601, a computing device generates an action request for fulfilment by one or more action vehicles. In an example, the computing device may include a road user device, another action vehicle, an ordinary vehicle, a governmental agency, an organization responsible for health and safety of society, transportation organization, and the like. Further, operation S601 may be performed similarly with operation S501 of FIG. 5.

In operation S602, the generated action request is broadcasted to one or more action vehicles via a network. In an example, the action request may be broadcasted to one or more action vehicles located within a reference range of the requesting computing device or within a reference range of a location at which the requested action is to be performed. In an example, the action request may specify the reference range. Further, the reference range may be automatically modified based on a number of responses received during a preset timeframe. For example, if no acceptance is received after 1 minute of broadcasting, the reference range may be expanded more and more until a predetermined number of acceptance may be received.

In operation S603, the requesting computing device receives an acceptance of the action request from one or more action vehicles. In an example, the action vehicle may perform a check as to whether the action vehicle may be capable of performing the action request being requested. More specifically, the action vehicle may determine whether the vehicle attributes meets the conditions specified by the action request. For example, the action vehicle may determine whether it has the actuators capable of performing the requested action. Further, the action vehicle may determine whether it would be able to perform the action request within the time specified by the action request. In addition, if multiple acceptances are received, the computing device may select an action vehicle of choice. Alternatively, the computing device may automatically select an action vehicle based on a preset criteria, such as performance review of the action vehicle, time required for performing the requested action, cost for performing the requested action and the like.

In operation S604, the action vehicle accepting the action request transmits evidence of actuators for the action request. For example, the action vehicle may provide vehicle specification, images, or certification (which may be provided by a proof collection device after performing an earlier action request) with respect to the actuators. However, aspects of the present disclosure are not limited thereto, such that the action vehicle may not provide such evidence if the required actuator is known to be present on every car (e.g., warning lights) per government regulation.

In operation S605, the action vehicle fulfills the requested action. In an example, the operation S605 may be performed similarly with operation S507 of FIG. 5.

In operation S606, the action vehicle or a proof collection device acquire proof of fulfilment. In an example, the action vehicle may perform its own proof collection of evidence of performance of the requested action. Alternatively, the computing device, upon receiving a notification of performance of or starting of the action request, may broadcast a request for a proof collection device to collect proof of fulfilment. In an example, the operation S606 may be performed similarly with operation S508 of FIG. 5.

In operation S607, the action vehicle or the proof collection device that acquired the proof of fulfilment transmits the proof of fulfilment to the computing device via a communication network.

In operation S608, the computing device confirms the proof of fulfilment and transmits the reward to the action vehicle and/or the proof collection device.

According to aspects of the present disclosure, in method of FIG. 6, the matching operation of FIG. 5 is modified. More specifically, creation of action actuator instructions and/or the proof collection instructions are outputted by algorithms stored in a memory of the action vehicle.

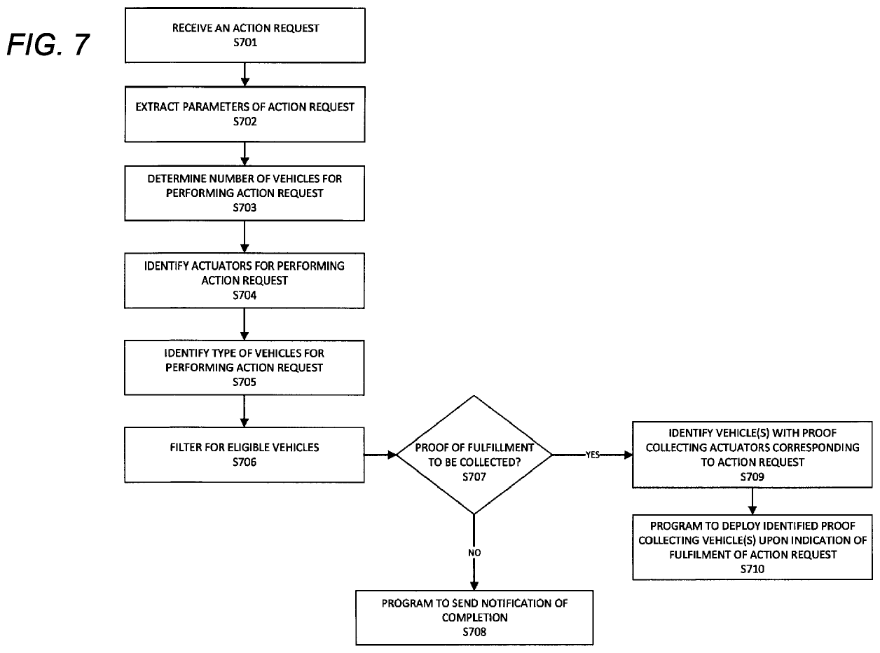

FIG. 7 shows a method for matching an action request to an action vehicle, according to aspects of the present disclosure.

In operation S701, a centralized server or an action vehicle receives an action request, which may be generated by a computing device. The computing device may be a mobile device, a stationary computer, a kiosk, a computing component of a vehicle or the like.

In operation S702, the centralized server or the action vehicle extracts the specified parameters or attributes of the action request. For example, the action request may have several parameters, which may be unpackaged and extracted for identifying qualified vehicles for performing of the action request. The parameters may include, without limitation, number of vehicles for performing the action request, required actuator(s) for performing the action request, timeframe of action performance, location of action performance, cost range, vehicle type, and the like.

In operation S703, a number of vehicles for performing the action request is identified by the centralized server or the action vehicle. In an example, if the number of vehicles necessary is greater than 1, then the centralized server or an action vehicle may automatically divide up the action request to multiple tasks to be performed by the participating or accepting action vehicles. The multiple tasks may be specified in relation to one another, which may specific a sub-action and/or a location of performance.

In operation S704, actuators for performing the action request is identified by the centralized server or the action vehicle. For example, the action request may specify that the action vehicle be equipped with external displays for display of signs or images.

In operation S705, the centralized server identifies a type of action vehicle for performing the action request. For example, if the action request is generated during a snowy day or is at a location with poor traction, action vehicles with all-wheel capabilities may be specified.

In operation S706, filtering of eligible vehicles is performed. In an example, if filtering is performed at the centralized server, the centralized server may remove unqualified action vehicles from consideration for the action request. If filtering is performed at the action vehicle, each action vehicle may determine whether it would qualify to perform the action request.

In operation S707, a determination of whether proof of fulfillment is to be obtained is made. If no such proof is to be obtained, the accepting vehicle is notified to transmit indication of completion of action request in operation S708.

If proof of fulfillment is to be obtained, an identification of proof collecting vehicles or devices with qualifying proof collecting actuators (e.g., camera, microphone, light measurer, biological sensor, and the like) may be made in operation S709. In an example, the proof collecting vehicles or devices may include the action vehicle performing the action request, another vehicle that may be located within a reference range of the action request, an unmanned aerial device (e.g., drone), or the like.

Once the qualifying proof collecting vehicles or devices are identified, the proof collecting vehicles or devices may be programmed to deploy upon receiving an indication of completion or fulfilment of the action request in operation S710.

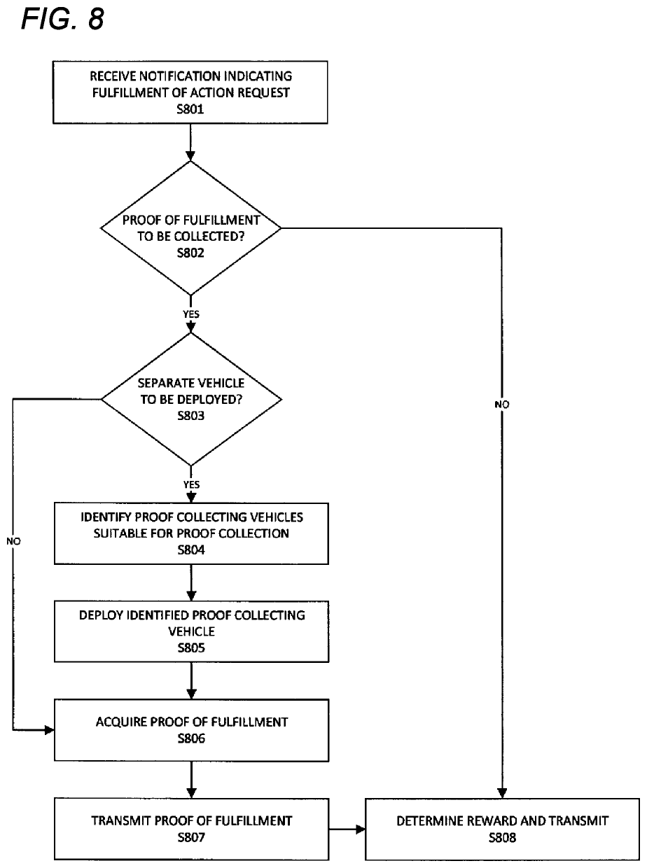

FIG. 8 shows a method for identifying a proof collection device for deployment, according to an aspect of the present disclosure.

In operation S801, a notification indicating fulfillment or completion of action request may be received from a respective action vehicle. The notification may be received at a centralized server or at a computing device that issued the action request.

In operation S802, a determination of whether proof of fulfillment is to be collected or acquired is made. In an example, the determination may be made manually by a user of the computing device. Alternatively, the determination may be automatically made by the centralized server or the computing device based on one or more attributes of the action request.

If it is determined that the proof of fulfillment is not to be collected, a reward is determined and transmitted to the action vehicle in operation S808.

If it is determined that the proof of fulfillment is to be collected, a determination of whether a separate vehicle is to be deployed is made in operation S803. If it is determined that a separate vehicle is not to be deployed in operation S803, the action vehicle collects proof of fulfillment in operation S806, and transmits the proof of fulfillment to either the computing device or the centralized server in operation S807. Further, upon transmission of the proof of fulfillment, a reward is determined and transmitted to the action vehicle in operation S808.

If it is determined that a separate vehicle is to be deployed in operation S803, proof collecting vehicles suitable for proof of fulfillment are identified in operation S804. In an example, the proof collecting vehicles may be identified based on their equipped actuators, distance from the location of performance of the action request, travel route/time, and mode of travel. The proof collecting vehicles may include, without limitation, another action vehicle, an unmanned aerial device (e.g., drone), a system of safety cameras, and the like.

Upon identification of suitable proof collecting vehicles in operation S804, one or more of the identified proof collecting vehicles are deployed in operation S805. A deployed prof collecting vehicle collects proof of fulfillment in operation S806, and transmits the proof of fulfillment to either the computing device or the centralized server in operation S807. Further, upon transmission of the proof of fulfillment, a reward is determined and transmitted to the action vehicle in operation S808.

Aspects of the present disclosure provide new services for various road users, such as cyclists and pedestrians, which may improve their safety, enjoyment and/or convenience while traveling. Further, vehicle owners may be incentivized to utilize advance capabilities of their cars to assist other road users or transportation authorities/civil services. Actions of these vehicles may be integrated with complementary actions of smart infrastructure, where available. In addition, gathering of behavioral data of road users may be gathered in shared roads and/or spaces.

Further, exemplary embodiments of the present disclosure provide an ability to match action requests from road users with available vehicles willing to fulfil those requests. An ability to schedule the requested action into routes of the road user and the vehicle executing the action may be further provided. Also, an ability to create proof that the action has been performed, for purposes of calculating a reward, may be provided. In addition to the above, ability to measure road user behavior in response to actions is provided. An ability to coordinate the use of sensors and/or actuators present in vehicles and smart infrastructure to fulfil action requests is also provided.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a system to bring together (i) requests from road users such as cyclists or pedestrians to improve their journey quality and/or enjoyment, and (ii) cars using their actuators to fulfil these requests, is provided.

According to another aspect of the present disclosure, a method for bring together (i) requests from road users such as cyclists or pedestrians to improve their journey quality and/or enjoyment and (ii) cars using their actuators to fulfil these requests, is provided.

According to an aspect of the present disclosure, a method is provided for fulfilling an action request via a vehicle. The method includes transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

According to another aspect of the present disclosure, the method further includes determining a fulfillment schedule for the target vehicle.

According to another aspect of the present disclosure, the actuator includes at least one of a pixelated head light, an external display, a sound system, a warning light or a spoiler.

According to yet another aspect of the present disclosure, the actuator performs a mechanical operation.

According to still another aspect of the present disclosure, the actuator performs an electrical operation.

According to another aspect of the present disclosure, the method further includes acquiring, by the target vehicle, proof of fulfillment; and transmitting, by the target vehicle and to the server, the acquired proof of fulfillment.

According to another aspect of the present disclosure, the method further includes acquiring, by an unmanned aerial vehicle, proof of fulfillment; and transmitting, by the unmanned aerial vehicle and to the server, the acquired proof of fulfillment.

According to yet another aspect of the present disclosure, the target vehicle is identified based on one or more vehicle attributes of the target vehicle.

According to still another aspect of the present disclosure, the target vehicle is identified based on a distance from the location of fulfillment.

According to a further aspect of the present disclosure, the method further includes receiving, from the target vehicle, a notification of fulfillment of the action request; determining, by the server, whether proof of fulfillment is to be collected; when the proof of fulfillment is determined to be collected, identifying, by the server, a proof collecting vehicle equipped with an actuator configured to collect the proof of fulfillment; and deploying, by the server, the proof collecting vehicle for collection of the proof of fulfillment.

According to another aspect of the present disclosure, the action request is generated in response to a manual input by a user of the computing device.

According to another aspect of the present disclosure, the action request is generated automatically by the computing device based on a bio-signal detected from the user.

According to yet another aspect of the present disclosure, the method further includes collecting, by a sensor, a bio-signal from the user; and generating, by the computing device, the action request when the bio-signal is irregular.

According to still another aspect of the present disclosure, the action request specifies providing illumination at the location of fulfillment.

According to another aspect of the present disclosure, the actuator is a warning light, and the action request specifies operating of the warning light at the location of fulfillment.

According to another aspect of the present disclosure, the method further includes communicating by the target vehicle with a computer controlling one or more devices installed on an infrastructure; and requesting, by the target vehicle to the computer, an operation of the one or more devices installed on the infrastructure for fulfillment of the action request.

According to yet another aspect of the present disclosure, the action request is fulfilled by a plurality of vehicles, the plurality of vehicles including the target vehicle.

According to still another aspect of the present disclosure, the method further includes receiving, from the target vehicle and at the computing device, an acceptance to fulfill the action request.

According to another aspect of the present disclosure, a user of the computing device is either a pedestrian or a rider of a non-motorized vehicle.

According to another aspect of the present disclosure, a non-transitory computer readable storage medium that stores a computer program, the computer program, when executed by a processor, causing a computer apparatus to perform a process for fulfilling an action request via a vehicle. The process includes transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

According to yet another aspect of the present disclosure, a computer apparatus for fulfilling an action request via a vehicle is provided. The computer apparatus includes a memory that stores instructions, and a processor that executes the instructions, in which, when executed by the processor, the instructions cause the processor to perform a set of operations. The set of operations includes transmitting, from a computing device and to a server, an action request for fulfillment by a vehicle, the action request specifying a location of fulfillment; identifying, by the server, a target vehicle equipped with an actuator configured to perform the action request among a plurality of vehicles; transmitting, from the server and to the target vehicle, the action request for fulfillment using the actuator of the target vehicle; routing, the target vehicle, to the location of fulfillment; and operating, by the target vehicle, the actuator for fulfilling the action request at the location of fulfillment.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The present application claims the benefit of U.S. Provisional Patent Application No. 62/735,221 filed on Sep. 24, 2018. The entire disclosure of the above-identified application, including the specifications, drawings and/or claims, is incorporated herein by reference in its entirety.

1. A method for fulfilling an action request via a vehicle, the method comprising:
transmitting, from a computing device and to a server, an action request for fulfillment by a vehicle, the action request specifying a location of fulfillment;
identifying, by the server, a target vehicle equipped with an actuator configured to perform the action request among a plurality of vehicles;
transmitting, from the server and to the target vehicle, the action request for fulfillment using the actuator of the target vehicle;
routing, the target vehicle, to the location of fulfillment; and
operating, by the target vehicle, the actuator for fulfilling the action request at the location of fulfillment.

2. The method of claim 1, further comprising determining a fulfillment schedule for the target vehicle.

3. The method of claim 1, wherein the actuator includes at least one of a pixelated head light, an external display, a sound system, a warning light or a spoiler.

4. The method of claim 1, wherein the actuator performs a mechanical operation.

5. The method of claim 1, wherein the actuator performs an electrical operation.

6. The method of claim 1, further comprising:
acquiring, by the target vehicle, proof of fulfillment; and
transmitting, by the target vehicle and to the server, the acquired proof of fulfillment.

7. The method of claim 1, further comprising:
acquiring, by an unmanned aerial vehicle, proof of fulfillment; and
transmitting, by the unmanned aerial vehicle and to the server, the acquired proof of fulfillment.

8. The method of claim 1, wherein the target vehicle is identified based on one or more vehicle attributes of the target vehicle.

9. The method of claim 1, wherein the target vehicle is identified based on a distance from the location of fulfillment.

10. The method of claim 1, further comprising:
receiving, from the target vehicle, a notification of fulfillment of the action request;
determining, by the server, whether proof of fulfillment is to be collected;
when the proof of fulfillment is determined to be collected, identifying, by the server, a proof collecting vehicle equipped with an actuator configured to collect the proof of fulfillment; and
deploying, by the server, the proof collecting vehicle for collection of the proof of fulfillment.

11. The method of claim 1, wherein the action request is generated in response to a manual input by a user of the computing device.

12. The method of claim 1, wherein the action request is generated automatically by the computing device based on a bio-signal detected from the user.

13. The method of claim 1, further comprising:
collecting, by a sensor, a bio-signal from the user; and
generating, by the computing device, the action request when the bio-signal is irregular.

14. The method of claim 1, wherein the action request specifies providing illumination at the location of fulfillment.

15. The method of claim 1,
wherein the actuator is a warning light, and
wherein the action request specifies operating of the warning light at the location of fulfillment.

16. The method of claim 1, further comprising:
communicating by the target vehicle with a computer controlling one or more devices installed on an infrastructure; and
requesting, by the target vehicle to the computer, an operation of the one or more devices installed on the infrastructure for fulfillment of the action request.

17. The method of claim 1, wherein the action request is fulfilled by a plurality of vehicles, the plurality of vehicles including the target vehicle.

18. The method of claim 1, further comprising:
receiving, from the target vehicle and at the computing device, an acceptance to fulfill the action request.

19. The method of claim 1, wherein a user of the computing device is either a pedestrian or a rider of a non-motorized vehicle.

20. A non-transitory computer readable storage medium that stores a computer program, the computer program, when executed by a processor, causing a computer apparatus to perform a process for fulfilling an action request via a vehicle, the process comprising:
transmitting, from a computing device and to a server, an action request for fulfillment by a vehicle, the action request specifying a location of fulfillment;
identifying, by the server, a target vehicle equipped with an actuator configured to perform the action request among a plurality of vehicles;
transmitting, from the server and to the target vehicle, the action request for fulfillment using the actuator of the target vehicle;
routing, the target vehicle, to the location of fulfillment; and
operating, by the target vehicle, the actuator for fulfilling the action request at the location of fulfillment.

21. A computer apparatus for fulfilling an action request via a vehicle, the computer apparatus comprising:
a memory that stores instructions, and
a processor that executes the instructions,
wherein, when executed by the processor, the instructions cause the processor to perform operations comprising:
transmitting, from a computing device and to a server, an action request for fulfillment by a vehicle, the action request specifying a location of fulfillment;
identifying, by the server, a target vehicle equipped with an actuator configured to perform the action request among a plurality of vehicles;
transmitting, from the server and to the target vehicle, the action request for fulfillment using the actuator of the target vehicle;
routing, the target vehicle, to the location of fulfillment; and
operating, by the target vehicle, the actuator for fulfilling the action request at the location of fulfillment.
